(19) United States
(12) Patent Application Publication
(10) Pub. No.: US 2011/0013706 A1
(43) Pub. Date: Jan. 20, 2011

(54) METHOD FOR TRANSMITTING SIGNALS IN A RADIO COMMUNICATION SYSTEM

(75) Inventor: Bernhard Raaf, Neuried (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 12/161,356

(22) PCT Filed: Jan. 4, 2007
(86) PCT No.: PCT/EP07/50068

§ 371 Date: Sep. 28, 2010

(30) Foreign Application Priority Data
Jan. 18, 2006 (EP) 06001062.6

(51) Int. Cl. H04L 27/00

(52) U.S. Cl. 375/259; 375/295

(57) ABSTRACT

A system is provided in which a transmission end provides at least one symbol in a frame or time slot with a guard interval which is extended in comparison with further symbols in the frame or time slot, the at least one symbol with the extended guard interval having a content which is known at the receiver end.

### CROSS REFERENCE TO RELATED APPLICATIONS

This application is based on and hereby claims priority to European Application No. 06001062.6 filed on 18 Jan. 2006, the contents of which incorporated herein by reference.

### BACKGROUND

The embodiments relate to a method for signal transmission in a radio communication system, particularly using OFDM (Orthogonal Frequency Division Multiple) symbols.

GB 2 394 869 A discloses the practice of fitting a transmission of OFDM symbols in a time slot defined for a CDMA (Code Division Multiple Access) transmission by providing the respective symbols with what are known as guard intervals (guard samples) of different duration.

Such guard intervals are used to prevent two successively transmitted symbols from being superimposed at the reception end caused by multipath propagation. By way of example, guard intervals are proportioned on the basis of what are known as scenarios in this case, for example, on the basis of different situations such as inner city or rural area.

In addition, U.S. Pat. No. 6,115,354 discloses the practice of providing control symbols in an OFDM transmission frame with a longer guard interval at the start of a frame than for subsequent data symbols.

In the course of further development of the 3^{rd} generation mobile radio UMTS standard (Universal Mobile Telecommunication Standard), also referred to as Evolved UTRA (E-UTRA) or Long Term Evolution (LTE), by the 3GPP (Third Generation Partnership Project), higher transmission rates are supported by considering use of an OFDMA (Orthogonal Frequency Division Multiplex Access) method for allocating physical resources to a multiplicity of connections or subscriber terminals in wide frequency bands of currently up to 20 MHz. Currently planned transmission schemes are shown in table form in the technical report 3GPP TR 25.814 V0.5.0 (2005-11) “Physical Layer Aspects for Evolved UTRA (Release 7)”, chapter 7.1.1, for example. This envisages the existence of different lengths of guard intervals, in this case, referred to as cyclic prefixes (CP), which are referred to as short and long cyclic prefixes.

In line with the proposal by the aforementioned GB 2 394 869 A, six guard intervals with a length of 4.69 us (=9 samples) and one guard interval with a length of 5.21 us (=10 samples) are used, according to table 7.1.1.1, in a subframe of length 0.5 ms at a frequency width of 1.25 MHz and using short guard intervals.

Which of the total of seven symbols in a subframe is provided with the longer guard interval appears to be random, however, since it is determined by means of a formula which is indicated beneath table 7.1.1.1.

### SUMMARY

It is therefore an aspect of the embodiments to specify a method for transmitting OFDM symbols in a transmission frame in which the advantages associated with a longer guard interval are used efficiently. This is achieved by the method, the radio communication system and the transmission device according to the independent patent claims. Further refinements can be found in the dependent patent claims.

The embodiments involve providing at least one symbol in a frame or time slot with a guard interval which is extended in comparison with other symbols in the frame or time slot, wherein the at least one symbol has a content which is known at the receiver end.

This advantageously results in a reduction in susceptibility to propagation time differences in comparison with the other symbols in the frame or time slot, which means that more reliable detection of the symbol at the reception end becomes possible.

In line with a first refinement, the at least one symbol is an OFDM symbol which has samples which are known at the receiver end.

In line with a second refinement, the at least one symbol is a pilot symbol. Increased protection of pilot symbols is of particular importance, since an undetected or incorrectly detected pilot symbol which is used at the reception end for channel estimation, for example, results in the other symbols in a frame or time slot also possibly being detected at a lower quality.

The radio communication system and the transmission device each have means for carrying out the method according to the invention.

### BRIEF DESCRIPTION OF THE DRAWINGS

These and other aspects and advantages will become more apparent and more readily appreciated from the following description of the exemplary embodiments, taken in conjunction with the accompanying drawings of which:

The embodiments are illustrated in more detail below with the aid of an exemplary embodiment. In this context,

FIG. 1 shows an exemplary structure of a radio communication system, and

FIG. 2 shows a frame or time slot according to the invention.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

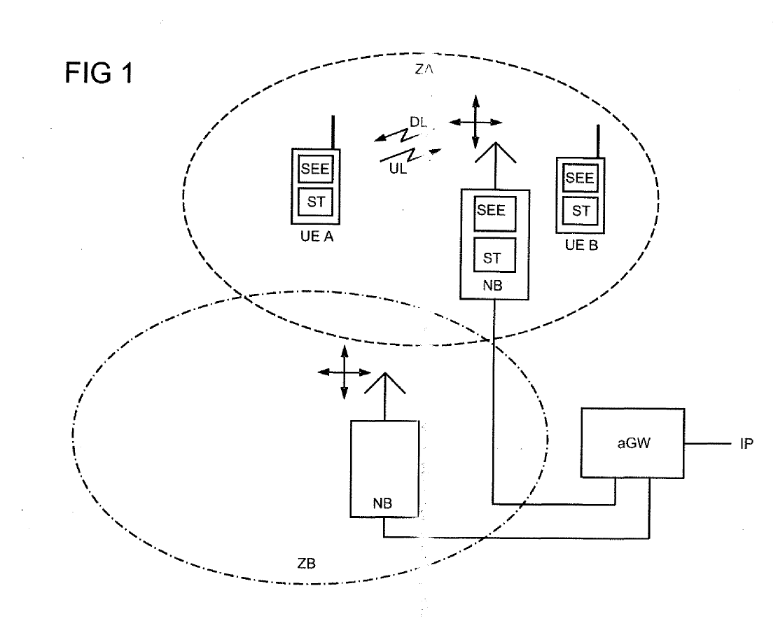

FIG. 1 shows the structure of a radio communication system, particularly according to the present level of E-UTRA or UMTS-LTE standardization, by way of example. What is known as access gateway aGW is connected to other components of the system or to other systems via an IP-based (IP—Internet Protocol) network. The access gateway aGW interchanges data traffic in the form of data packets with this network. In addition, the access gateway aGW is connected to a multiplicity of base stations NB (Node B) which each supply at least one radio cell ZA or ZB with radio resources. The base stations NB shown by way of example are in turn connected to subscriber terminals UE A, UE B via a radio interface. The radio interface transmits signals in the uplink UL and the downlink DL. To support the method according to the embodiment, the base stations NB and the subscriber terminals UE A, UE B each have at least one transmission/reception device SEE for sending and receiving signals and each have a control device ST, particularly for controlling the transmission/reception devices SEE in the base station NB and the subscriber terminals UE A, UE B.

The embodiments are used to particular advantage for the further development of the UMTS standard, described in the introduction. In this case, a longer guard interval can be attributed to the “first reference symbol”, for example, described in chapter 7.1.1.2.2 of the technical report TR 25.814. By way of example, this reference symbol is used for channel estimation, measuring the channel quality or searching for cells. By way of example, as indicated in FIG. 7.1.1.2.2-1, this reference symbol is transmitted in second place within a subframe, but it is also conceivable for there to be a different arrangement within the frame on the basis of chapter 7.1.1.2.2. By way of example, the position may also vary from subframe to subframe and between adjacent radio cells.

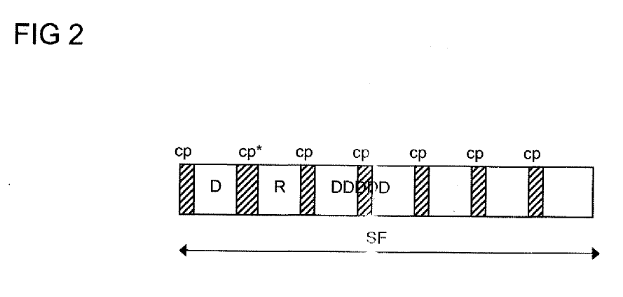

FIG. 2 shows an exemplary embodiment which is based on the structure of a subframe in line with FIG. 7.1.1.2.2-1 of the technical report TR 25.814. What is shown is a subframe SF of a subcarrier. By way of example, it is assumed that the first reference symbol R, which is provided with an extended guard interval cp*, is arranged as a second symbol in the subframe. The other symbols D in the subframe carry useful and/or signaling data, hence control data, for example. A second reference symbol could be provided in a subframe in the same way as shown in FIG. 7.1.1.2.2-1, and could be provided with an extended guard interval like the first reference symbol R. By way of example, this could also be controlled on the basis of a current transmission situation, for example, a scenario as mentioned at the outset or a current traffic load.

The invention is not limited to the illustrated structure for a frame but rather may be used in a wide variety of configurations of frames or time slots and also refinements of symbols with contents similar to the reference symbol cited by way of example.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1. A method for transmitting signals, in which the transmission end provides at least one symbol (R) in a frame (SF) or time slot with a guard interval (cp*) which is extended in comparison with other symbols (D) in the frame (SF) or time slot, wherein the at least one symbol (R) with the extended guard interval (cp*) has a content which is known at the receiver end.

2. The method as claimed in claim 1, wherein
the at least one symbol (R) is in the form of an OFDM symbol which has samples which are known at the receiver end.

3. The method as claimed in claim 1 or 2, in which
the at least one symbol (R) is in the form of a pilot symbol or reference symbol.

4. The method as claimed in one of the preceding claims, in which
the other symbols (D) in the frame (SF) or time slot transmit useful, signaling and/or control data.

5. A radio communication system, having at least one transmission device (NB, UE) and a reception device (UE, NB) for transmitting signals via a radio interface, wherein the transmission device has means for providing at least one symbol (R) in a frame (SF) or time slot with a guard interval (cp*) which is extended in comparison with other symbols (D) in the frame (SF) or time slot, and wherein the reception device (UE) has means (SEE, ST) for detecting a content, known to the reception device (UE), of the at least one symbol (R).

6. A transmission device (NB, UE) in a radio communication system, having means (SEE, ST) for providing at least one
symbol (R) in a frame (SF) or time slot with a guard interval (cp*) which is extended in comparison with other symbols
(D) in the frame (SF) or time slot, wherein the at least one symbol (R) with the extended guard interval (cp*) has a content which is known at the receiver end, and for transmitting the symbols (D, R) via a radio interface to at least one reception device (UE, NB).

7. The transmission device (NB, UE) as claimed in claim 6, which is in the form of a base station or in the form of a subscriber terminal.
